(19) United States
(12) Patent Application Publication
(10) Pub. No.: US 2018/0071758 A1
(43) Pub. Date: Mar. 15, 2018

(54) AUTOMATIC SPRAY GUN

(71) Applicant: ANEST IWATA Corporation, Kanagawa (JP)

(72) Inventor: Takayuki HATA, Kanagawa (JP)

(21) Appl. No.: 15/564,610

(22) PCT Filed: Apr. 1, 2016
(86) PCT No.: PCT/JP2016/060880

§ 371 Date: Oct. 5, 2017

(30) Foreign Application Priority Data
Apr. 9, 2015 (JP) 2015-079682

(51) Int. Cl. B05B 7/06; B05B 1/30

(52) U.S. Cl. CPC B05B 7/066; B05B 1/3046

(57) ABSTRACT

A spray gun having a body formed of a front end, a middle, and a rear end, a gas cap attached to the front end, and a needle that opens/closes a liquid nozzle attached to the middle. The front end has a through-hole extending from a front side, on which the gas cap is disposed, toward the middle. The middle includes a protrusion in the through-hole of the front end and a through-hole leading to a liquid supply port formed in the middle and extending from a front end side through the protrusion toward the rear end. The liquid nozzle is in the through-hole of the protrusion. The needle extends from a rear end side through the through-hole of the middle so that a distal end of the needle is in a distal opening of the liquid nozzle in an insertable/removable manner.

### TECHNICAL FIELD

The invention relates to an automatic spray gun.

### BACKGROUND ART

An automatic spray gun of a similar type to the invention is disclosed, for example, in the Japanese Unexamined Patent Application Publication (Kokai) No. 2007-021459 (see Patent Literature 1). This automatic spray gun includes a body with a front opening, a paint nozzle fitted in the front opening of the body, and a gas cap attached to the front of the body and having an air discharge port for discharging air to the distal end of the paint nozzle. The paint nozzle protrudes ahead of the body. The distal end of the paint nozzle forms a paint discharge port. The paint nozzle further has a central aperture through which paint passes. After passing through the central aperture, the paint is discharged from the paint discharge port. The paint discharge port is opened and closed by a needle valve coming in and out of contact with the port. The needle valve is movable through the central aperture forwardly and backwardly by using an operation device. The body includes a front body part with the front opening, a rear body part in which the operation device is provided, and a middle body part located between the front and rear body parts. In the middle body part, a paint supply path is formed, which extends from a paint supply port formed in an outer peripheral surface of the middle body part and communicates with the central aperture. The paint supply path includes a corrosive-resistant portion which is formed of metal, glass or resin having corrosion resistance against water-based paint.

### RELATED ART DOCUMENTS

### Patent Literature

PTL 1: Japanese Unexamined Patent Application Publication (Kokai) No. 2007-021459

### SUMMARY OF INVENTION

### Technical Problem

According to the automatic spray gun disclosed in the Patent Literature 1, the paint supply path is formed in the middle body part. The front body part is attached to the middle body part to come into contact with a lateral face of the middle body part so that a liquid nozzle attached to the front body part is connected to the paint supply path of the middle body part.

A sealing member comprising an 0-ring covers the outer periphery of a contact portion of the liquid nozzle. The sealing member thus seals a gap between the front body part and the middle body part.

The paint is therefore sealed at a point where the sealing member is disposed and therefore adheres to the front body part as well.

At the time of cleaning the automatic spray gun, it is necessary to clean the front body part in addition to the liquid nozzle and the middle body part, increasing a number of components to be cleaned.

The invention has been made in light of the foregoing circumstances. An object of the invention is to provide an automatic spray gun having a decreased number of components to be cleaned.

### Solution to Problem

To accomplish the object mentioned above, the invention may be configured as below.
(1) An automatic spray gun of the invention includes a spray gun body including a front end part, a rear end part, and a middle part disposed between the front end part and the rear end part; a gas cap attached to the front end part; a liquid nozzle attached to the middle part; and a needle configured to open and close the liquid nozzle. The front end part has a through-hole extending from a front side of the front end part, on which the gas cap is disposed, toward the middle part. The middle part includes a protrusion which is inserted in the through-hole of the front end part, and a through-hole that is in communication with a liquid supply port provided on the middle part and that is formed from the front end part side toward the rear end part, the through hole extending through the protrusion. The liquid nozzle is fitted in the through-hole of the protrusion. The needle extends from the rear end part through the through-hole of the middle part. The needle has a distal end that is inserted in a distal opening of the liquid nozzle in an insertable and removable manner.
(2) There is provided a configuration according to (1), in which the front end part includes a horn gas supply port which receives gas supplied into gas ejection ports formed in horns of the gas cap;

the horn gas supply port communicates with a horn gas supply path which is formed by a clearance between an inner peripheral surface of the through-hole of the front end part and an outer peripheral surface of the protrusion, the horn gas supply path being configured to supply the gas to the horns of the gas cap; and

the horn gas supply path includes a space serving as a gas reservoir in an area where the horn gas supply port communicates with the horn gas supply path, the gas reservoir being formed by positioning the inner peripheral surface of the front end part circumferentially away from the outer peripheral surface of the protrusion.
(3) There is provided a configuration according to either (1) or (2), in which

a plurality of gas passages are provided around the outside of a liquid-flowing passage of the liquid nozzle, and gas is supplied through each of the gas passages to a slit-like gas ejection port which is formed by a central opening of the gas cap and a distal end of the liquid nozzle;

the gas passages of the liquid nozzle have rear ends connected to a slit gas supply path which is a space serving as a gas reservoir, the slit gas supply path being circumferentially formed as a clearance between an outer peripheral surface of the liquid nozzle and an inner peripheral surface of the protrusion;

the protrusion has a slit gas supply aperture provided thereon, and the slit gas supply aperture communicates with the slit gas supply path and opens in the outer peripheral surface of the protrusion;

the slit gas supply aperture opens in the outer peripheral surface of the protrusion, and the front end part includes a slit gas supply port provided thereon, and the slit gas supply port opens in the inner peripheral surface of the front end part; and

the slit gas supply port is located to coincide with the slit gas supply aperture and is in communication with the slit gas supply aperture.
(4) There is provided a configuration according to any one of (1) to (3), in which the through-hole of the front end part has a tapered portion with an inner diameter increasing toward the middle part, and the protrusion of the middle part has a tapered portion with an outer diameter decreasing toward the front end part. When the front end part and the middle part are assembled together, the alignment for them can be carried out through the tapered portion of the through-hole of the front end part and the tapered portion of the protrusion of the middle part.
(5) There is provided a configuration according to any one of (1) to (4), in which the middle part has a tapered portion on a rear end part side, the tapered portion having an outer diameter decreasing toward the rear end part, and the rear end part has a tapered portion with an inner diameter increasing toward the middle part, the tapered portion being configured to receive the tapered portion of the middle part, which has the outer diameter decreasing toward the rear end part. When the middle part and the rear end part are assembled together, the alignment for them can be carried out through the tapered portion of the middle part, which has the outer diameter decreasing toward the rear end part, and the tapered portion of the rear end part, which has the inner diameter increasing toward the middle part.
(6) There is provided a configuration according to any one of (1) to (5), in which

the automatic spray gun further comprises:

a piston disposed at a rear end of the needle, an elastic body disposed on a rear end side of the piston and configured to bias the piston forward, and a lid disposed on a rear end side of the rear end part and configured to receive an opposite end of the elastic body to the piston; and

the rear end part includes an opening which receives the piston, and a working gas supply port configured to receive gas supplied to a space between the middle part and the piston to drive the piston, the working gas supply port communicating with the space between the middle part and the piston.
(7) There is provided a configuration according to (6), in which

the automatic spray gun further comprises:

a seal cartridge inserted in the through-hole of the middle part from the rear end part side, the seal cartridge including a gas seal portion configured to seal gas supplied from the working gas supply port from flowing toward the liquid nozzle and a liquid seal portion configured to seal liquid supplied from the liquid supply port from flowing toward the rear end part, the gas seal portion being integrated with the liquid seal portion; and

the needle extends through a through-hole of the seal cartridge and the through-hole of the middle part, and a distal end of the needle is inserted in a distal opening of the liquid nozzle in an insertable and removable manner.

One embodiment of the invention provides an automatic spray gun having a decreased number of components to be cleaned.

### BRIEF DESCRIPTION OF DRAWINGS

FIG. 1 is a perspective view of an automatic spray gun according to an embodiment of the invention;

FIG. 2 is an exploded perspective view of the automatic spray gun of FIG. 1;

FIG. 3 is a plan view of the automatic spray gun of FIG. 1 as viewed from an attachment face thereof;

FIG. 4 is a plan view of the automatic spray gun of FIG. 1 as viewed from a gas cap thereof;

FIG. 5 is a sectional view along the line E-E of FIG. 4;

FIG. 6 is a sectional view along the line B-B of FIG. 4;

FIG. 7 is a sectional view along the line A-A of FIG. 4;

FIG. 8 is a sectional view along the line D-D of FIG. 4;

FIG. 9 is a sectional view along the line C-C of FIG. 4;

FIG. 10 is a sectional view along the line F-F of FIG. 4; and

FIG. 11 is a sectional view along the line G-G of FIG. 4.

### DESCRIPTION OF EMBODIMENT

A mode for carrying out the invention (hereinafter, referred to as an embodiment) will now be described in details with reference to attached drawings. Same numerals are used to represent the same elements throughout the description of the embodiment.

Terms such as “distal (end)” and “front (or forward)” represent a side of each member or the like, which lies in a liquid-spraying direction, and terms such as “rear (end)” and “rear (or rearward)” represent a side of each member or the like, which lies in the direction opposite to the liquid-spraying direction, unless otherwise specified.

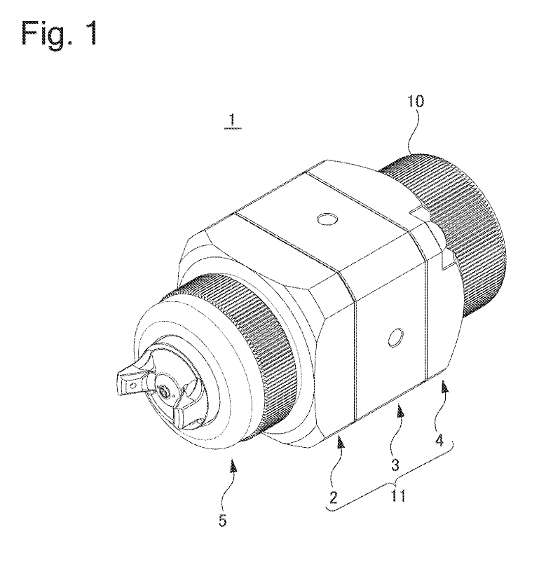

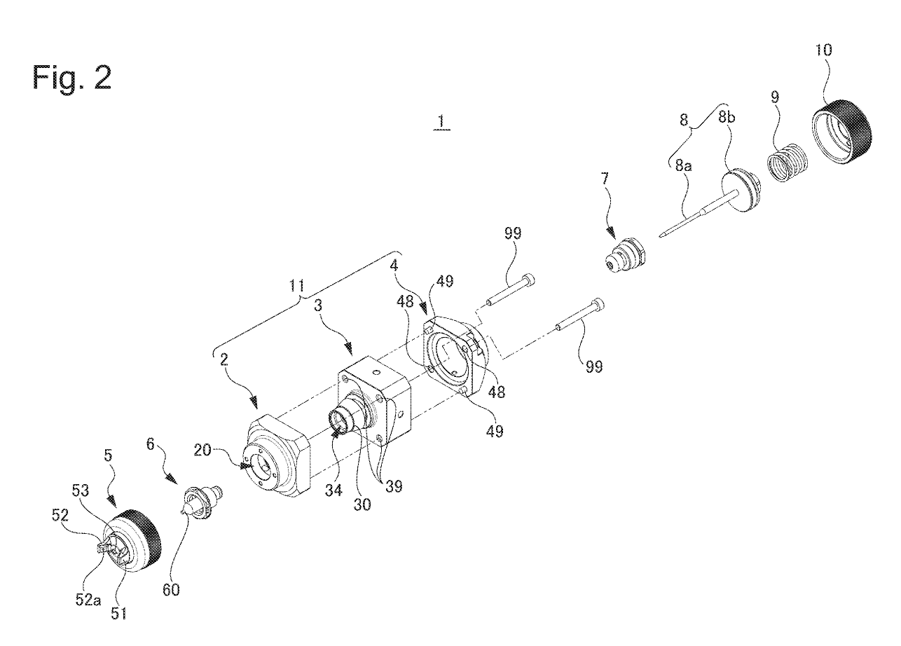

FIG. 1 is a perspective view of an automatic spray gun 1 according to an embodiment of the invention. FIG. 2 is an exploded perspective view of the automatic spray gun 1.

As shown in FIGS. 1 and 2, the automatic spray gun 1 includes a spray gun body 11 having a front end part 2, a middle part 3, and a rear end part 4, and a gas cap 5 attached to the front end part 2. The middle part 3 is disposed between the front end part 2 and the rear end part 4.

As shown in FIG. 2, the front end part 2 has a through-hole 20 extending from a front side of the front end part 2, on which the gas cap 5 is disposed, toward the middle part 3.

The middle part 3 has a protrusion 30 inserted in the through-hole 20 of the front end part 2. The automatic spray gun 1 includes a liquid nozzle 6 attached to the protrusion 30.

Although details will follow later, the automatic spray gun 1 includes a seal cartridge 7 attached to the middle part 3, a needle 8 in which a piston 8b is attached to a rear end of a rod-like main body 8a, an elastic body 9 which is disposed on a rear end side of the piston 8b and formed of a coil spring configured to bias the needle 8 forward, and a lid 10 which is disposed on a rear end side of the rear end part 4 and configured to receive an opposite end of the elastic body 9 to the piston 8b.

The present embodiment provides a configuration in which the piston 8b disposed at a rear end of the needle 8 is a discrete component, and attached to the rod-like main body 8a. However, the needle 8 does not necessarily have to be configured this way, and may be formed of the rod-like main body 8a and the piston 8b integrated with each other.

The automatic spray gun 1 according to the present embodiment is a manifold type of automatic spray gun which is attached to a manifold that is an attachment portion of a painting apparatus and supplied with liquid sprayed from the liquid nozzle 6 and gas for atomizing the sprayed liquid.

The automatic spray gun 1 according to the present embodiment can be suitably used to apply liquid such as paint. The liquid to be used is not limited to paint and may be selected as appropriate.

More specifically, as shown in FIG. 2, the gas cap 5 has a central opening 53. A distal end 60 of the liquid nozzle 6 is disposed within the central opening 53 so as to form a clearance between the central opening 53 and the distal end 60 itself. The central opening 53 of the gas cap 5 and the distal end 60 of the liquid nozzle 6 form a slit-like gas ejection port. Gas which is ejected from the slit-like gas ejection port brings the liquid sprayed from the liquid nozzle 6 into an atomized liquid state.

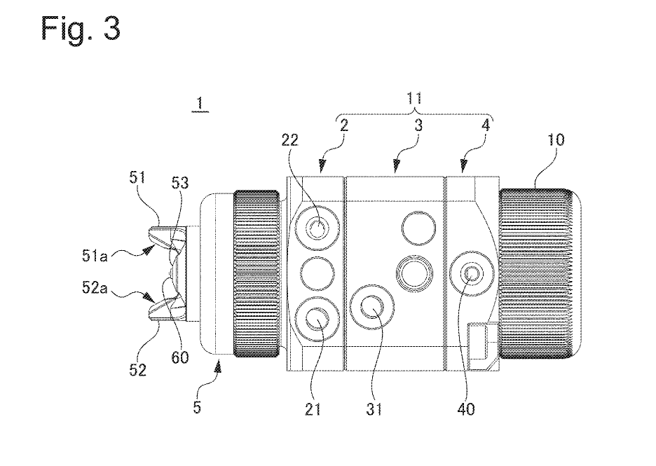

A spray form of the atomized liquid is adjusted by gas ejected from gas ejection ports 51a and 52a (see FIG. 3) formed in a pair of horns 51 and 52 provided on the gas cap 5.

For example, if a flow rate of the gas ejected from the gas ejection ports 51a and 52a is reduced, a form of the atomized liquid being sprayed (spray pattern) gets closer to a circle and becomes suitable for applying liquid to a small area.

If the flow rate of the gas ejected from the gas ejection ports 51a and 52a is increased, the circular spray pattern is flattened by the gas ejected from the gas ejection ports 51a and 52a into an oval shape whose spray pattern is longitudinally broadened, and becomes suitable for applying liquid to a large area.

The gas to be used may preferably be compressed air or the like. Instead of air, a gas such as nitrogen and argon may also be used. The gas to be used may be optionally changed as needed.

The following description will provide details of supply routes for the gas supplied to the slit-like gas ejection port and the gas ejection ports 51a and 52a, the liquid supplied to the liquid nozzle 6, and the like, with reference to assembly of the parts.

As discussed above, the automatic spray gun 1 according to the present embodiment is attached to the manifold, not shown, of the painting apparatus. The gas and the liquid are supplied through the manifold. The automatic spray gun 1 has an attachment face that is attached to the manifold. The gas and liquid supply ports of the automatic spray gun 1 are disposed on a side where there is the attachment face.

FIG. 3 is a plan view of the automatic spray gun as seen from the attachment face attached to the manifold.

As shown in FIG. 3, the front end part 2 has gas supply ports in an attachment face-side face. The gas supply ports are supplied with gas from the manifold.

More specifically, the front end part 2 has a horn gas supply port 21 which receives gas supplied to the gas ejection ports 51a and 52a formed in the horns 51 and 52 of the gas cap 5, and a slit gas supply port 22 which receives gas supplied to the slit-like gas ejection port.

The middle part 3 has a liquid supply port 31 in a face on the attachment face side. The liquid supply port 31 receives liquid supplied to the liquid nozzle 6.

The rear end part 4 has a working gas supply port 40 in a face on the attachment face side. The working gas supply port 40 receives gas for driving the piston 8b to insert/remove the distal end of the needle 8 (rod-like main body 8a) in/from a distal opening of the liquid nozzle 6, that is, to open/close the liquid nozzle 6.

(Gas Supply to the Horns)

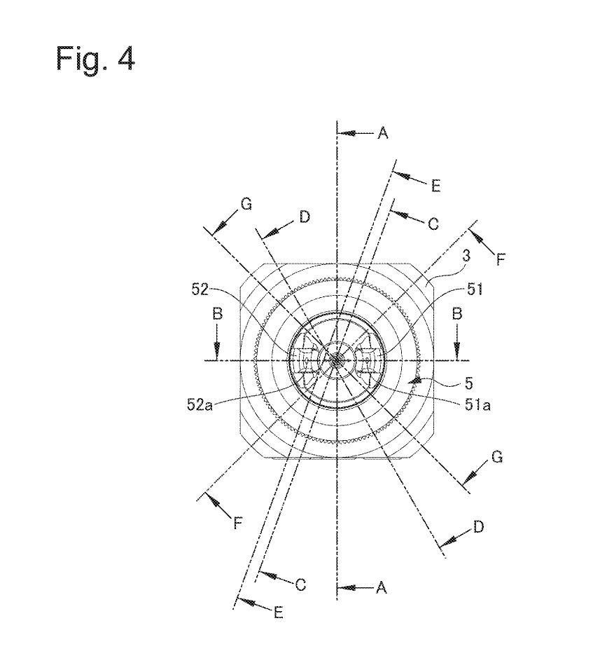

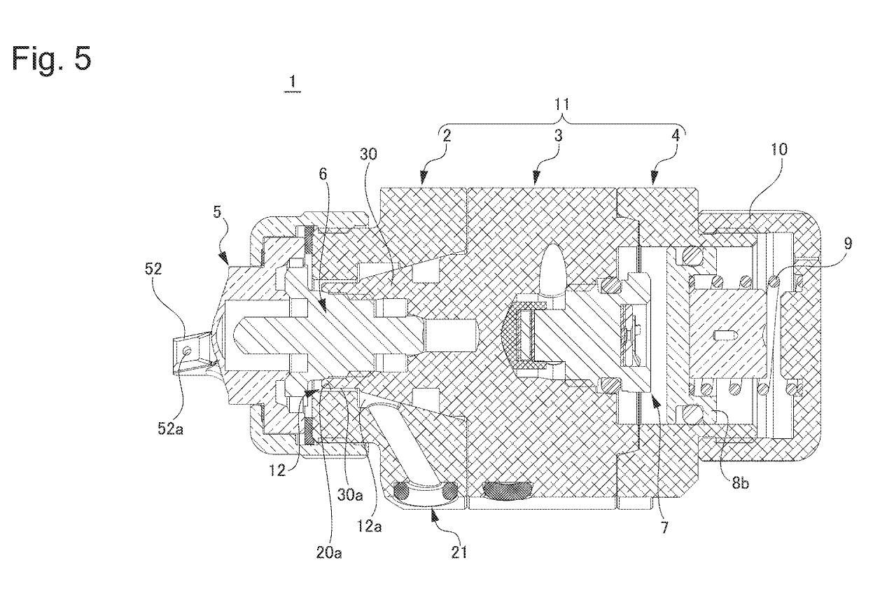

The following is a detail of the supply route for the gas supplied to the gas ejection ports 51a and 52a formed in the horns 51 and 52, including a description of a configuration of the supply route and the like, with reference to FIGS. 4 and 5.

FIG. 4 is a plan view of the automatic spray gun 1 with the gas cap 5 as viewed from the gas cap 5, and FIG. 5 is a sectional view along the line E-E of FIG. 4.

FIG. 5 omits a liquid-flowing passage formed within the liquid nozzle 6. This is because FIG. 5 shows an oblique section along the line E-E of FIG. 4 in order to illustrate a supply path for the gas supplied from the horn gas supply port 21.

As discussed above, the horn gas supply port 21 is formed in the attachment face-side face of the front end part 2. The horn gas supply port 21 receives the gas supplied to the gas ejection ports 51a and 52a formed in the horns 51 and 52 of the gas cap 5.

As shown in FIG. 5, the horn gas supply port 21 communicates with a horn gas supply path 12. The horn gas supply path 12 is formed of a clearance between an inner peripheral surface 20a of the through-hole 20 of the front end part 2 and an outer peripheral surface 30a of the protrusion 30 of the middle part 3. The horn gas supply path 12 supplies gas to the horns 51 and 52 of the gas cap 5.

The front end part 2 therefore has a through-hole extending from the horn gas supply port 21 to the horn gas supply path 12 (portion 12a of the horn gas supply path 12).

The portion 12a of the horn gas supply path 12, with which the horn gas supply port 21 communicates, is formed of a space serving as a gas reservoir, which extends in a circumferential direction. The portion 12a of the horn gas supply path 12 is so designed that the inner peripheral surface 20a of the front end part 2 is positioned away from the outer peripheral surface 30a of the protrusion 30 of the middle part 3.

As a result, the gas supplied from the horn gas supply port 21 is circumferentially pressure-equalized in the space serving as the gas reservoir which is formed in the portion 12a in communication with which the horn gas supply port 21. The pressure-equalized gas is then supplied through the horn gas supply path 12 toward the gas cap 5 side.

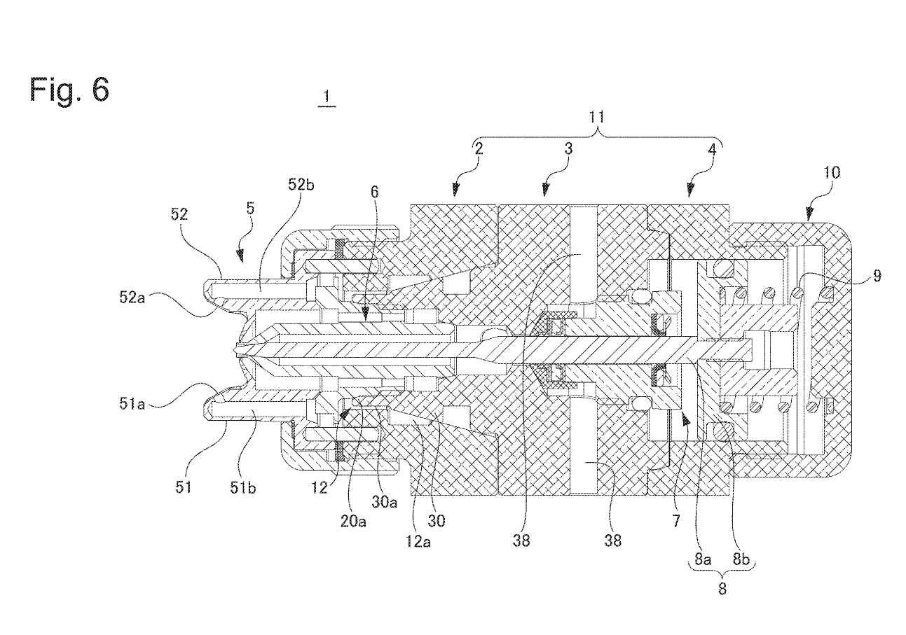

FIG. 6 is a sectional view along the line B-B of FIG. 4. That is to say, FIG. 6 is a section passing through the gas ejection ports 51a and 52a of the horns 51 and 52.

As shown in FIG. 6, the gas flowing through the horn gas supply path 12 is supplied to gas passages 51b and 52b communicating with the gas ejection ports 51a and 52a within the horns 51 and 52, and ejected from the gas ejection ports 51a and 52a. The gas supplied to the horn gas supply path 12 is circumferentially pressure-equalized as mentioned earlier, which equalizes flow rates of the gas supplied to the gas passages 51b and 52b.

As a result, flow rates of the gas ejected from the gas ejection ports 51a and 52a are equalized, too.

(Gas Supply to the Slit-Like Gas Ejection Port)

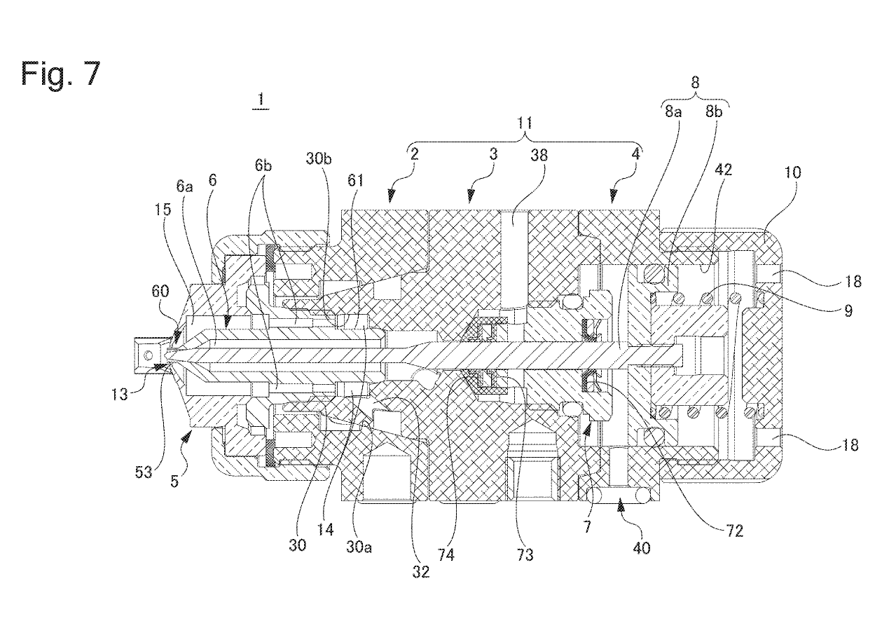

The following is a detail of the supply route for the gas supplied to a slit-like gas ejection port 13 (see FIG. 7), including a description of a configuration of the supply route and the like, with reference to FIGS. 4, 7 and 8.

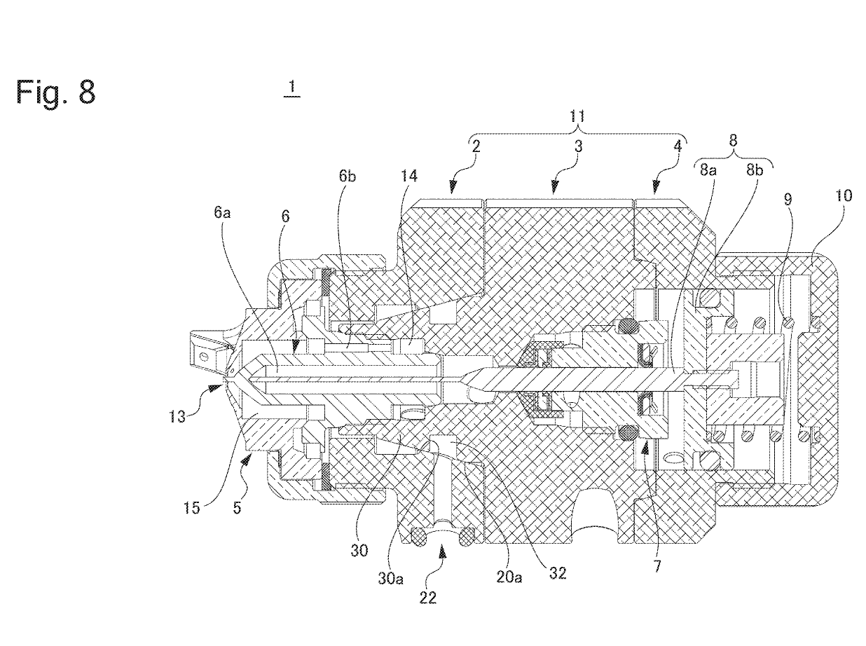

FIG. 7 is a sectional view along the line A-A of FIG. 4, and FIG. 8 is a sectional view along the line D-D of FIG. 4.

Again, FIG. 8 shows an oblique section along the line D-D of FIG. 4 to illustrate a supply path for the gas supplied from the slit gas supply port 22.

In FIG. 8, therefore, a liquid-flowing passage 6a formed within the liquid nozzle 6 is shown as if not penetrating through the liquid nozzle 6. In fact, however, the liquid nozzle 6 opens at a distal end 60 as shown in FIG. 7. The distal end of the needle 8 (rod-like main body 8a) is inserted in the distal opening of the liquid nozzle 6.

As shown in FIG. 7, the liquid nozzle 6 includes a plurality of gas passages 6b around the outside of the liquid-flowing passage 6a formed within the liquid nozzle 6. Each of the gas passages 6b is those for supplying gas to the slit-like gas ejection port 13 which is formed of a central opening 53 of the gas cap 5 and the distal end 60 of the liquid nozzle 6.

The gas passages 6b of the liquid nozzle 6 are communicated with a slit gas supply path 14 at rear ends thereof. The slit gas supply path 14 is a space serving as a gas reservoir which is circumferentially formed as a clearance between an outer peripheral surface 61 of the liquid nozzle 6 and an inner peripheral surface 30b of the protrusion 30 of the middle part 3.

The protrusion 30 of the middle part 3 has a slit gas supply aperture 32 which communicates with the slit gas supply path 14 and opens in the outer peripheral surface 30a of the protrusion 30.

As shown in FIG. 8, a slit gas supply port 22 is provided on an outer side (face serving as the attachment face) of the front end part 2. The slit gas supply port 22 opens in the inner peripheral surface 20a of the front end part 2. The middle part 3 has a slit gas supply aperture 32 provided thereon. The slit gas supply aperture 32 opens in the outer peripheral surface 30a of the protrusion 30 of the middle part 3. The slit gas supply port 22 is located to be aligned with the slit gas supply aperture 32. The slit gas supply port 22 is in communication with the slit gas supply aperture 32.

To be more specific, in the front end part 2, there is formed a through-hole extending from the slit gas supply port 22 to a point in the inner peripheral surface 20a of the front end part 2, which coincides with the slit gas supply aperture 32 opening in the outer peripheral surface 30a of the protrusion 30 of the middle part 3.

The gas supplied to the slit gas supply port 22 is thus circumferentially pressure-equalized in the slit gas supply path 14 which is the space serving as the gas reservoir.

The gas which has been circumferentially pressure-equalized is supplied to the slit-like gas ejection port 13 through the plurality of gas passages 6b circumferentially arranged in an outer periphery of the liquid nozzle 6. Since the gas supplied to the plurality of gas passages 6b of the liquid nozzle 6 is circumferentially pressure-equalized as described above, the gas supplied to the plurality of gas passages 6b of the liquid nozzle 6 flows at uniform flow rates.

As a result, a space 15 which is formed of the liquid nozzle 6 and the gas cap 5 immediately behind the slit-like gas ejection port 13 is thoroughly supplied with gas from the plurality of gas passages 6b of the liquid nozzle 6 at substantially the same flow rates.

Consequently, the space 15 is also pressure-equalized, so that the gas is ejected from the slit-like gas ejection port 13 in a circumferentially uniform ejection amount. This enables a favorable liquid-spraying condition and atomization of the liquid.

If the ejection amount of the gas ejected from the slit-like gas ejection port 13 is circumferentially uneven, a spray direction of the liquid ejected from the liquid nozzle 6 deviates according to the unevenness. If this occurs, the liquid cannot be properly sprayed in the forward direction. Besides, the liquid ejected from where the gas ejection amount is large is of a small particle size, whereas the liquid ejected from where the gas ejection amount is small is of a large particle size. The sprayed liquid is thus deteriorated in homogeneity of particle size.

However, if the ejection amount of the gas which is ejected in the circumferential direction of the slit-like gas ejection port 13 is uniform as previously mentioned, the liquid is properly sprayed in the forward direction and is also uniform in particle size. This enables a favorable liquid-spraying condition.

(Liquid Supply to the Liquid Nozzle)

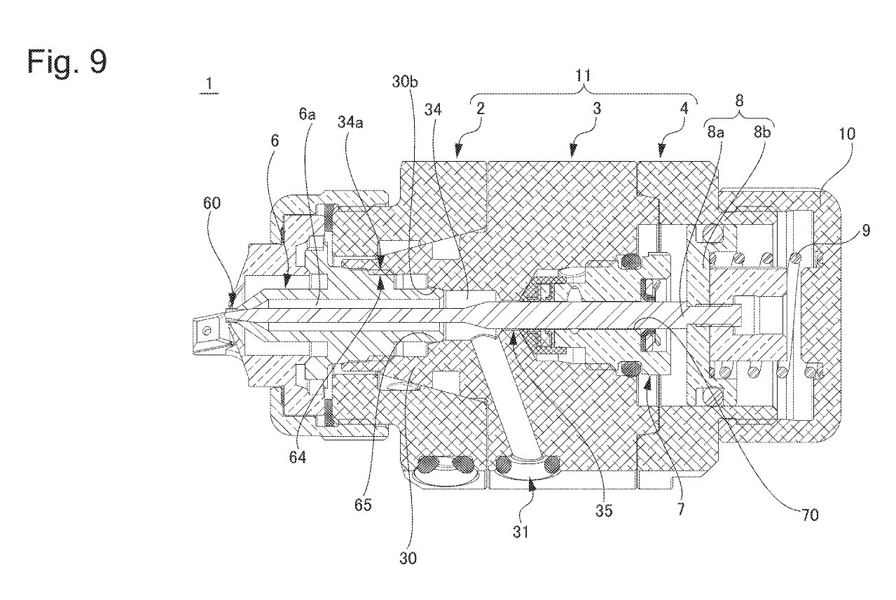

The following is a detail of the supply route for the gas supplied to the liquid nozzle 6, including a description of a configuration of the supply route and the like, with reference to FIG. 4 and FIG. 9 which is a sectional view along the line C-C of FIG. 4.

As already mentioned, the liquid supply port 31 is formed in an attachment face-side face of the middle part 3. The liquid supply port 31 receives the liquid supplied to the liquid nozzle 6.

The middle part 3 has a through-hole 34 formed therein. The through-hole 34 is in communication with the liquid supply port 31 formed in the middle part 3 and extends through the protrusion 30 that is formed from a front end part 2 side toward the rear end part 4 side. The liquid nozzle 6 is fitted in the through-hole 34 of the protrusion 30.

In the middle part 3, there are formed the through-hole 34 extending through the middle part 3 in a front-back direction, and a through-hole connecting the through-hole 34 to the liquid supply port 31.

The attachment of the liquid nozzle 6 according to the present embodiment will be described below. The middle part 3 has an internal thread structure that is provided in an inner peripheral surface of a front-side portion 34a of the through-hole 34 of the middle part 3. The liquid nozzle 6 has an external thread structure that is provided in an outer peripheral surface of a rear-side portion 64 of the liquid nozzle 6. The liquid nozzle 6 is fitted in the through-hole 34 of the protrusion 30 by the internal thread and the external thread being threadedly connected to each other.

The liquid nozzle 6 has a rear end 65 which comes into contact with the inner peripheral surface 30b of the through-hole 34 of the protrusion 30 of the middle part 3 to seal a gap between the liquid nozzle 6 and the protrusion 30.

The liquid flowing through the through-hole 34 is thus supplied only to the liquid-flowing passage 6a through which the liquid in the liquid nozzle 6 flows, and is prevented from leaking to an outer peripheral side of the liquid nozzle 6.

The through-hole 34 is so formed that an inner diameter thereof decreases from both the front side and the rear side at a position behind the protrusion 30 of the middle part 3, that is, slightly in the rear of a portion where the liquid supply port 31 leads to the through-hole 34, and thus that the inner diameter of the through-hole 34 becomes substantially close to an outer diameter of the needle 8 (rod-like main body 8a), to thereby form a narrow section 35.

Inserted in the through-hole 34 of the middle part 3 is a seal cartridge 7 described below. The seal cartridge 7 is inserted into the through-hole 34 of the middle part 3 from the rear end part 4 side of the middle part 3. A distal end of the seal cartridge 7 then comes into contact with a rear end-side wall surface of the narrow section 35 to position the seal cartridge 7.

In the center of the seal cartridge 7, there is formed a through-hole 70 through which the needle 8 (rod-like main body 8a) is inserted. The rod-like main body 8a of the needle 8 is inserted into the through-hole 70 of the seal cartridge 7 from the rear end part 4 side of the middle part 3 with the seal cartridge 7 attached to the middle part 3. The distal end of the rod-like main body 8a of the needle 8 is then inserted into the distal opening of the distal end 60 of the liquid nozzle 6 to dispose the needle 8.

According to the foregoing configuration in which the liquid nozzle 6 is fitted in the through-hole 34 of the protrusion 30 of the middle part 3, the front end part 2 is prevented from contacting the liquid. This eliminates the necessity of cleaning the front end part 2 like conventional automatic spray guns.

The foregoing configuration further prevents the rear end part 4 from contacting the liquid since the seal cartridge 7 is disposed in the rear end side of the middle part 3. The rear end part 4 therefore also does not need to be cleaned. Portions which contact the liquid are concentrated in the middle part 3, which means that portions which need to be cleaned are only the middle part 3 and the members concentrated in the middle part.

As the liquid nozzle 6 and the seal cartridge 7 are concentrated in the middle part 3, the liquid nozzle 6 and the seal cartridge 7 are enhanced in accuracy in axial alignment (positional accuracy).

For example, if the liquid nozzle 6 is disposed in the front end part 2, and the seal cartridge 7 is disposed in the middle part 3, in order to align a central axis of the liquid nozzle 6 and that of the seal cartridge 7, it is necessary to not only precisely control the positional accuracy of an attachment portion of the liquid nozzle 6 in the front end part 2 and the positional accuracy of an attachment portion of the seal cartridge 7 in the middle part 3 but also precisely control assembly accuracy of the front end part 2 and the middle part 3.

In the present embodiment, since both the liquid nozzle 6 and the seal cartridge 7 are provided in the middle part 3, it is only necessary to precisely control the positional accuracy of the attachment portions of the liquid nozzle 6 and the seal cartridge 7 in the middle part 3.

Since the needle 8 is positioned by the through-hole 70 of the seal cartridge 7, the distal end of the needle 8 (rod-like main body 8a) can be accurately positioned with respect to the distal opening at the distal end 60 of the liquid nozzle 6.

For example, if the positional accuracy of the needle 8 (rod-like main body 8a) with respect to the distal opening of the liquid nozzle 6 is poor, when the needle 8 is shifted rearward to open the distal opening of the liquid nozzle 6, the distal end of the needle 8 does not keep coaxial with the center of the distal opening when moving in the front-back direction. This creates unevenness in opening condition for ejecting the liquid, so that favorable liquid ejection is not achieved.

The present embodiment, however, enhances the positional accuracy of the distal end of the needle 8 (rod-like main body 8a) with respect to the distal opening of the liquid nozzle 6. This makes it possible to avoid or reduce the unevenness in the opening condition for ejecting the liquid and achieve the favorable liquid ejection.

(Gas Supply for driving the Piston)

A configuration of the supply route of gas for driving the piston 8b and a configuration for piston operation will be explained below in details with reference to FIG. 7.

As shown in FIG. 7, the rear end part 4 has an opening 42 which receives the piston 8b disposed at the rear end of the needle 8.

The elastic body 9 is disposed on the rear end side of the piston 8b. The elastic body 9 is formed of a coil spring which biases the piston 8b forward. The lid 10 which receives the opposite end of the elastic body 9 to the piston 8b is disposed on the rear end side of the rear end part 4.

In a normal state where the piston 8b is not being driven, the piston 8b is biased forward by the elastic body 9, and the distal end of the needle 8 (rod-like main body 8a) is inserted in the distal opening of the liquid nozzle 6 to block the distal opening.

As already briefly mentioned, the working gas supply port 40 is formed in an attachment face-side face of the rear end part 4. The working gas supply port 40 communicates with a space between the middle part 3 and the piston 8b. Gas is supplied from the working gas supply port 40 into the space between the middle part 3 and the piston 8b to drive the piston 8b. In other words, the rear end part 4 has a through-hole extending from the working gas supply port 40 to the space between the middle part 3 and the piston 8b.

If the gas is supplied from the working gas supply port 40, therefore, the piston 8b moves rearward against a biasing force of the elastic body 9. The distal end of the needle 8 (rod-like main body 8a) inserted in the distal opening of the liquid nozzle 6 then also moves rearward, which opens the distal opening of the liquid nozzle 6. The liquid is then ejected from the distal opening.

In order for a smooth rearward motion of the piston 8b, the lid 10 has a through-hole 18 from which air in a space in which the elastic body 9 is provided can be released outside.

To stop the liquid ejection, for example, it is only necessary to extract the gas in the space between the middle part 3 and the piston 8b through the working gas supply port 40.

The gas extraction reduces pressure in the space between the middle part 3 and the piston 8b. The piston 8b is accordingly moved forward again by the biasing force of the elastic body 9. The distal end of the needle 8 (rod-like main body 8a) is then inserted into the distal opening of the liquid nozzle 6, which stops the ejection of the liquid.

Referring to the seal cartridge 7, a gas seal 72 is disposed on a rear end side of the seal cartridge 7. The gas seal 72 blocks the gas supplied from the working gas supply port 40 from flowing toward the liquid nozzle 6. On a front end side of the seal cartridge 7, there are provided liquid seal portions 73 and 74 which block the liquid supplied from the liquid supply port 31 (not shown in FIG. 7) from flowing toward the rear end part 4 side.

The seal cartridge 7 is a cartridge in which the gas seal 72 is integrated with the liquid seal portions 73 and 74, and therefore has a compact configuration.

An edge (inner diameter side) of the gas seal 72, which contacts the needle 8 (rod-like main body 8a), is bent toward the rear end part 4 along the needle 8 (rod-like main body 8a) to improve a sealing performance against the gas flowing toward the liquid nozzle 6.

The liquid seal portions 73 and 74 have distal ends which are bent in an opposite direction to the gas seal 72, or toward the front end part 2, along the needle 8 (rod-like main body 8a) to improve a sealing performance against the liquid flowing toward the rear end part 4.

It is consequently possible to achieve compactification and high sealing performance.

In the case of a usage pattern where prolonged piston operation is repeated for a long term, a small amount of the liquid may leak and flow toward the rear end part 4 in spite of the sealing by the seal cartridge 7.

To solve the issue, the present embodiment provides the middle part 3 with a detection hole 38 through which the subject portion of the seal cartridge 7 can be seen, and thus makes it possible to detect leakage without difficulty.

The detection hole 38 comprises three detection holes disposed at three places in the middle part 3.

More specifically, a first detection hole 38 is formed, in consideration of ease of looking thereinto, so as to open in an opposite face of the automatic spray gun 1 to the attachment face where the automatic spray gun 1 is attached to the manifold, that is, an opposite face to the face where the liquid supply port 31 is formed, as shown in FIG. 7.

The other two detection holes 38 are separately formed so as to open in respective faces of the lateral side of the attachment face where the automatic spray gun 1 is attached to the manifold, as shown in FIG. 6.

If an attempt is made to look into the detection holes 38 in a situation where the painting apparatus is in such a position that the first detection hole 38, which is formed in the opposite face to the face where the liquid supply port 31 is disposed, is difficult to look into, leakage check still can be carried out with ease by looking into either one of the other two detection holes 38, which is easier to look into.

In addition to further description of the configuration of the automatic spray gun 1, an example of assembling work of the automatic spray gun 1 will also be explained with reference to FIGS. 2, 10 and 11.

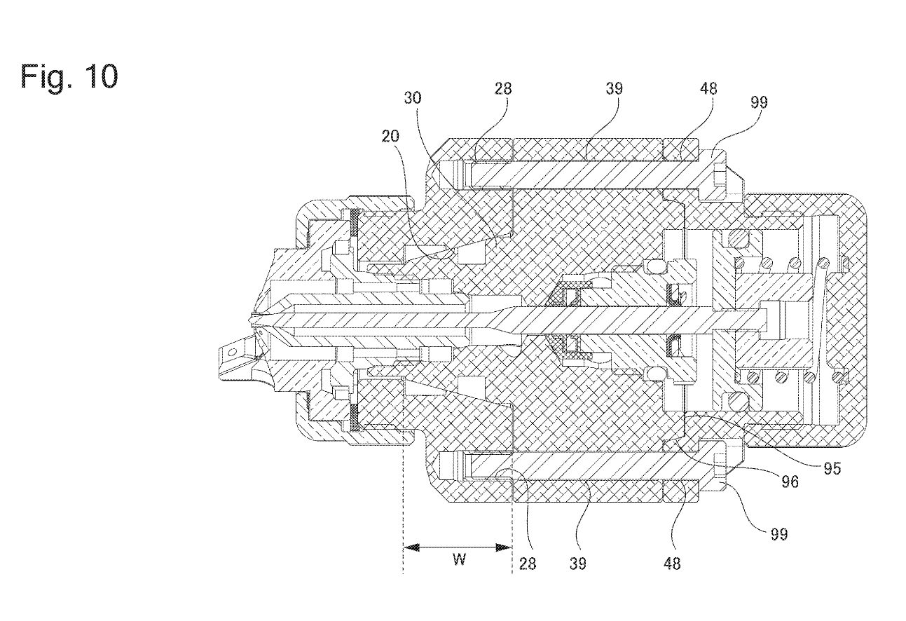

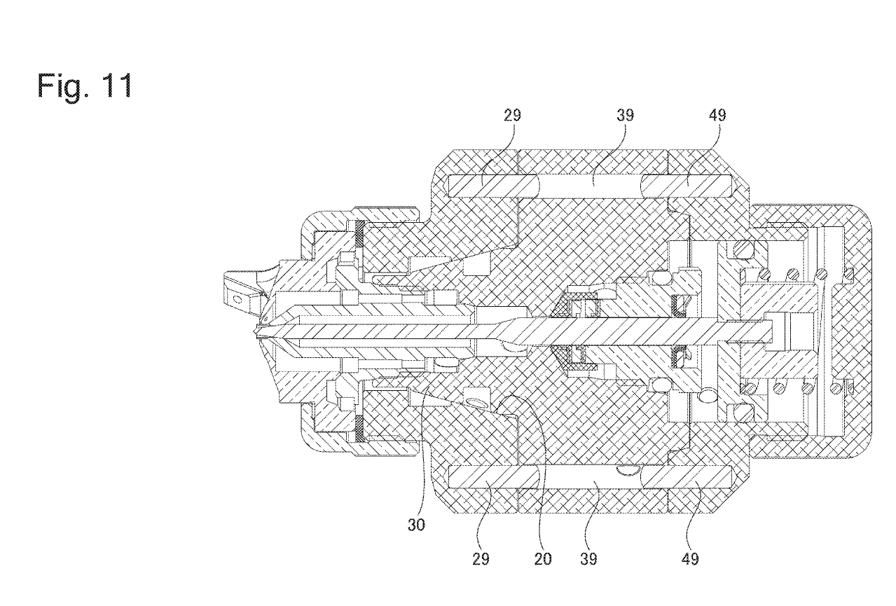

FIG. 10 is a sectional view along the line F-F of FIG. 4, and FIG. 11 is a sectional view along the line G-G of FIG. 4.

As shown in FIG. 2, the middle part 3 has pin holes 39. The pin holes 39 are formed through the middle part 3 at four corners of the middle part 3 so as to extend from a face on the front end part 2 side to a face on the rear end part 4 side.

The rear end part 4 includes pins 49 at two diagonal corners of four corners of a face on the middle part 3 side. The pins 49 are projecting toward the middle part 3.

Although not shown in FIG. 2, the front end part 2 also includes pins 29 at two diagonal corners of four corners of a face on the middle part 3 side, as shown in FIG. 11. The pins 29 are projecting toward the middle part 3.

The pins 29 of the front end part 2 are disposed in positions opposed to the pins 49 disposed in the rear end part 4 (coaxial positions to the respective pins 49).

At the time of assembling the front end part 2, the middle part 3, and the rear end part 4, therefore, temporary joints can be made by fitting the pins 29 of the front end part 2 and the pins 49 of the rear end part 4 into the pin holes 39 of the middle part 3.

As shown in FIG. 2, the rear end part 4 further has pin holes 48 at the other two corners where pin 49 is not provided. The pin holes 48 penetrate the rear end part 4 to extend from the face on the middle part 3 side to a rear end of the rear end part 4.

Although not shown in FIG. 2, the front end part 2 also has bottomed pin holes 28 at the other two corners where there pin 29 is not provided, as shown in FIG. 10.

When coupling pins 99 for integrating the front end part 2, the middle part 3, and the rear end part 4 are inserted into the pin holes in a direction from the rear end part 4 to the front end part 2, the front end part 2, the middle part 3, and the rear end part 4 are integrally coupled together.

An example of a specific assembling process of the automatic spray gun 1 thus configured will now be explained with reference to FIGS. 2, 10 and 11.

First, the front end part 2 and the middle part 3 are assembled together by inserting the protrusion 30 of the middle part 3 into the through-hole 20 of the front end part 2 and fitting the pins 29 of the front end part 2 into the pin holes 39 of the middle part 3.

As can be noted from FIGS. 10 and 11, the protrusion 30 of the middle part 3 is formed to include a tapered portion with an outer diameter decreasing toward the front end part 2, whereas the through-hole 20 of the front end part 2 has a tapered portion with an inner diameter increasing toward the middle part 3 (see an area W in FIG. 10).

The tapered portion of the through-hole 20 of the front end part 2 and the tapered portion of the protrusion 30 of the middle part 3 are combined with each other, so that the front end part 2 and the middle part 3 are accurately aligned when assembled together.

In a configuration where a tapered hole and a tapered protrusion are fitted together like the present embodiment, it is almost unnecessary to allow backlash to be caused. Because of the tapered portions that are provided in the through-hole 20 of the front end part 2 and the protrusion 30 of the middle part 3, the front end part 2 and the middle part 3 are properly assembled together without backlash.

Again with reference to FIG. 2, the explanation will be continued. As already discussed, the liquid nozzle 6 is threadedly connected to the through-hole 34 of the protrusion 30 of the middle part 3.

Subsequently, the seal cartridge 7 is inserted into the through-hole 34 of the middle part 3 from the rear side to be attached to the middle part 3.

After the attachment of the seal cartridge 7 is completed, the pins 49 of the rear end part 4 are fitted into the pin holes 39 of the middle part 3 to carry out the mounting of the rear end part 4.

As shown in FIG. 10, the middle part 3 includes a tapered portion 95 on the rear end part 4 side. The tapered portion 95 has an outer diameter that decreases toward the rear end part 4. The rear end part 4 includes a tapered portion 96 provided on the middle part 3 side. The tapered portion 96 has an inner diameter that increases toward the rear end of the middle part 3 which receives the tapered portion 95.

The tapered portion 95 of the middle part 3, the outer diameter thereof decreasing toward the rear end part 4, and the tapered portion 96 of the rear end part 4, the inner diameter thereof increasing toward the middle part 3, also enable an accurate alignment of the middle part 3 and the rear end part 4 at the time of assembling the middle part 3 and the rear end part 4.

After the front end part 2, the middle part 3, and the rear end part 4 are assembled together in the foregoing manner, they are integrally coupled to each other using the coupling pins 99. The needle 8 and the elastic body 9 are then attached in this order to the rear end part 4 from the rear side thereof, and the lid 10 is fitted to the rear end part 4.

The bottomed pin holes 28 of the front end part 2 each has an internal thread structure in an inner peripheral surface thereof, and the coupling pins 99 each has an external thread structure on a distal end side thereof. The integral coupling is carried out by screwing the external thread structures of the coupling pins 99 with the respective internal thread structures of the pin holes 28.

Lastly, the gas cap 5 is attached to the front end part 2, and the assembly of the automatic spray gun 1 is completed.

The above-described assembling process is just an example, and the assembly may be carried out in a different order.

As stated earlier, the front end part 2 and the middle part 3 can be properly assembled together without backlash in the present embodiment.

This allows the gas cap 5 attached to the front end part 2 to be placed accurately in a predetermined position relative to the liquid nozzle 6. Therefore, for example, the central opening 53 of the gas cap 5 does not deflect with respect to the distal end 60 of the liquid nozzle 6, so that the slit-like gas ejection port 13 can be formed with a circumferentially uniform slit width. This creates a more favorable spray pattern of the sprayed liquid.

The invention has been described on the basis of the specific embodiment. The invention, however, is not limited to the embodiment discussed above and may be modified or improved as necessary. It is obvious for one skilled in the art that modification and improvement are also included in the technical scope of the invention. The embodiments may be combined in any manner.

The present patent application claims priority under the Japanese Patent Application No. 2015-79682 filed on Apr. 9, 2015. The entire disclosure of the Japanese Patent Application No. 2015-79682 filed on Apr. 9, 2015, including the description, claims, drawings, and abstract, is incorporated herein by reference in its entirety.

### REFERENCE SIGNS LIST

1 automatic spray gun

2 front end part

3 middle part

4 rear end part

5 gas cap

6 liquid nozzle

6a liquid-flowing passage

6b gas passage

7 seal cartridge

8 needle

8a rod-like main body

8b piston

9 elastic body

10 lid

11 spray gun body

12 horn gas supply path

12a portion

13 slit-like gas ejection port

14 slit gas supply path

15 space

20 through-hole

20a inner peripheral surface

21 horn gas supply port

22 slit gas supply port

28 bottomed pin hole

29 pin

30 protrusion

30a outer peripheral surface

30b inner peripheral surface

31 liquid supply port

32 slit gas supply aperture

34 through-hole

34a front-side portion

35 narrow portion

38 detection hole

39 pin hole

40 working gas supply port

48 pin hole

49 pin

51, 52 horn

51a, 52a gas ejection port

53 central opening

60 distal end

61 outer peripheral surface

64 rear-side portion

65 rear end

70 through-hole

72 gas seal

73, 74 liquid seal portion

95 tapered portion

96 tapered portion

99 coupling pin

1. An automatic spray gun comprising:
a spray gun body including a front end part, a rear end part, and a middle part disposed between the front end part and the rear end part;
a gas cap attached to the front end part;
a liquid nozzle attached to the middle part; and
a needle configured to open and close the liquid nozzle,
wherein the front end part has a through-hole extending from a front side of the front end part, on which the gas cap is disposed, toward the middle part;
wherein the middle part includes:
a protrusion which is inserted in the through-hole of the front end part, and
a through-hole that is in communication with a liquid supply port provided on the middle part and that is formed from the front end part side toward the rear end part, the through-hole extending through the protrusion;
wherein the liquid nozzle is fitted in the through-hole of the protrusion; and
wherein the needle extends from the rear end part through the through-hole of the middle part, and a distal end of the needle is inserted in a distal opening of the liquid nozzle in an insertable and removable manner.

2. The automatic spray gun according to claim 1,
wherein the front end part includes:
a horn gas supply port which receives gas supplied into gas ejection ports formed in horns of the gas cap;
wherein the horn gas supply port communicates with a horn gas supply path which is formed by a clearance between an inner peripheral surface of the through-hole of the front end part and an outer peripheral surface of the protrusion, the horn gas supply path being configured to supply the gas to the horns of the gas cap; and
wherein the horn gas supply path includes a space serving as a gas reservoir in an area where the horn gas supply port communicates with the horn gas supply path, the gas reservoir being formed by positioning the inner peripheral surface of the front end part circumferentially away from the outer peripheral surface of the protrusion.

3. The automatic spray gun according to claim 1,
wherein a plurality of gas passages are provided around the outside of a liquid-flowing passage of the liquid nozzle, and gas is supplied through each of the gas passages to a slit-like gas ejection port which is formed by a central opening of the gas cap and a distal end of the liquid nozzle;
wherein the gas passages of the liquid nozzle have rear ends connected to a slit gas supply path which is a space serving as a gas reservoir, the slit gas supply path being circumferentially formed as a clearance between an outer peripheral surface of the liquid nozzle and an inner peripheral surface of the protrusion;
wherein the protrusion has a slit gas supply aperture provided thereon, and the slit gas supply aperture communicates with the slit gas supply path and opens in the outer peripheral surface of the protrusion;
wherein the slit gas supply aperture opens in the outer peripheral surface of the protrusion, and the front end part includes a slit gas supply port provided thereon, and the slit gas supply port opens in the inner peripheral surface of the front end part; and
wherein the slit gas supply port is located to coincide with the slit gas supply aperture and is in communication with the slit gas supply aperture.

4. The automatic spray gun according to claim 1,
wherein the through-hole of the front end part has a tapered portion with an inner diameter increasing toward the middle part;
wherein the protrusion of the middle part has a tapered portion with an outer diameter decreasing toward the front end part; and
wherein when the front end part and the middle part are assembled together, the alignment for them is capable of being carried out through the tapered portion of the through-hole of the front end part and the tapered portion of the protrusion of the middle part.

5. The automatic spray gun according to claim 1,
wherein the middle part has a tapered portion on a rear end part side, the tapered portion having an outer diameter decreasing toward the rear end part;
wherein the rear end part has a tapered portion with an inner diameter increasing toward the middle part, the tapered portion being configured to receive the tapered portion of the middle part, which has the outer diameter decreasing toward the rear end part; and
wherein when the middle part and the rear end part are assembled together, the alignment for them is capable of being carried out through the tapered portion of the middle part, which has the outer diameter decreasing toward the rear end part, and the tapered portion of the rear end part, which has the inner diameter increasing toward the middle part.

6. The automatic spray gun according to claim 1,
wherein the automatic spray gun further comprises:
a piston disposed at a rear end of the needle;
an elastic body disposed on a rear end side of the piston and configured to bias the piston forward; and
a lid disposed on a rear end side of the rear end part and configured to receive an opposite end of the elastic body to the piston; and
wherein the rear end part includes:
an opening which receives the piston; and
a working gas supply port configured to receive gas supplied to a space between the middle part and the piston to drive the piston, the working gas supply port communicating with the space between the middle part and the piston.

7. The automatic spray gun according to claim 6,
wherein the automatic spray gun further comprises:
a seal cartridge inserted in the through-hole of the middle part from the rear end part side, the seal cartridge including a gas seal portion configured to seal gas supplied from the working gas supply port from flowing toward the liquid nozzle and a liquid seal portion configured to seal liquid supplied from the liquid supply port from flowing toward the rear end part, the gas seal portion being integrated with the liquid seal portion; and
wherein the needle extends through a through-hole of the seal cartridge and the through-hole of the middle part, and a distal end of the needle is inserted in a distal opening of the liquid nozzle in an insertable and removable manner.
